(19) United States
(12) Patent Application Publication
(10) Pub. No.: US 2003/0236700 A1
(43) Pub. Date: Dec. 25, 2003

(54) Method for improving of service brokers' quality of service

(75) Inventors: Andreas Arning, Rottenburg (DE); Frank Leymann, Aidlingen (DE); Dieter Roller, Schoenaich (DE); Roland Seiffert, Herrenberg (DE)

Correspondence Address: Leslie A. Van Leeuwen, International Business Machines Corporation, Intellectual Property Law Department, 11400 Burnet Road, Austin, TX, 78758, US

(73) Assignee: INTERNATIONAL BUSINESS MACHINES CORPORATION, Armonk, NY

(21) Appl. No.: 10/401,639

(22) Filed: Mar. 27, 2003

(30) Foreign Application Priority Data
Jun. 25, 2002 (EP) 02014149.5

(51) Int. Cl. G06F 17/60

(52) U.S. Cl. 705/11; 705/10

(57) ABSTRACT

The present invention relates to a computerized method applicable to a set of parties connected via a network, and in particular it relates to a method and system for improving the search for services offered via said network. Said parties are Service Providers offering said services, Service Requesters needing said services, and Service Brokers maintaining information about said services and service providers. Said Service Brokers assist said Service Requestors in finding, for a particular service, the best services from the best Service Providers ranked by the importance for said Service Requestor. Obviously, the acceptance of a particular Service Broker by a particular Service Requestor depends on the capability of providing a (ranked) list of services that best meet the demands of a particular Service Requester. It is proposed to exploit data mining technology to achieve the proper ranking of said list created as a result of a Service Requester's request by providing at least said list (402) to a trained data-mining model (412) that then generates the proper ranked list (414) The trained data-mining model (412) is created by training an untrained data-mining model with some or all of the following information:

a. Properties of the offered service such as a description of the service,

b. Queries (406) that Service Requesters have submitted,

c. The non-ranked lists of services that have been derived from said queries (402),

d. Feedback information provided by the Service Requester about his preferences,

e. Properties of the Service Requester,

f. Properties of the Service Provider. (FIG. 4).

### BACKGROUND OF THE INVENTION

1.1 Field of the Invention

The present invention relates to a computerized method applicable to a set of parties connected via a network, and in particular it relates to a method and system for improving the finding of services offered via said network.

1.2 Description and Disadvantages of Prior Art

The present invention is related to the area of Internet technology, however could also be applied to Intranets as well.

The Internet as we know it today is mostly document centric. That means, companies and even private homes maintain web sites with documents that can be viewed by the visitors of the web sites. Search engines, such as Yahoo!™ or Google™, support the capability to locate documents that have certain character strings within the document. Users typically specify their queries as Boolean expressions of character strings or numbers. The expression “airfare AND cheap”, for example, might be used to find all documents that contain the character string “airfare” and the character string “cheap”. The search engine then would present all documents that contain those two character strings. Furthermore, instead of just presenting the set of found documents, the search engine presents them as a list in descending order of significance; that means the presumably most important one at the top of the list. Several mechanisms exist to determine the significance of a particular document, such as the proximity of the terms used in the query or the position of the terms in the found documents.

The Internet of the future not only will be a place where private homes and businesses are exhibiting documents, but it will be a place where businesses and possibly even private homes offer services. These services, called Web Services, can be anything from simple services, such as the checking of a credit card number to complex services, such as the processing of home mortgage. There is no need that the offered service is delivered via the Internet itself, for example the construction of a house is a perfectly valid service that could be offered.

The Service Oriented Architecture (SOA), as described in “The Tao of e-business services”, authored by Steve Burbeck and published by the IBM Corporation, is the architectural underpinning of Web Services, and thus of the service-oriented Web. The architecture defines three distinct components that interact with each other:

Service Providers publishing the availability of services

Service Brokers registering and categorizing published services and provide search services.

Service Requesters using broker services to find a needed service and then employing the service.

When a Service Requestor needs a particular service, the Service Requester would go to the Service Broker and ask for a list of services that match the service requestor's demand. This is similar to the situation in the content-oriented Web where a requester asks a search engine to obtain a list of qualified documents. Identical to the content-oriented Web the acceptance of a service broker depends on the quality of the results of a service requestor's query; that means how good do the found services match the expectation of the service requestor. The better the services match the services the Service Requestor expected, the better is typically the acceptance of the Service Broker by a particular Service Requester. And more Service Requestors and thus rendered services in general improve the revenue and profit of the Service Broker. Typically the Service Broker sorts the list of found services by relevance to the Service Requester's query. That means, the most relevant service is shown first, followed by the next relevant service. Typically the list of services is truncated using some threshold, such as a number specified by the service requestor (using a query such as “Give me the 25 most important services that . . . ”).

The relevance of services is typically determined by comparing the information available about the service, such as price, delivery schedule, functional description with the appropriate information supplied in the query. Comparison is typically done via some algorithms that map the individual criteria to some numeric value and then feed these numeric values into some formula to come up with a final significance value.

In the context of a service-oriented architecture, one would expect the following scenario:

1. A Service Requestor requests a list of appropriate services from a Service Broker.

2. The Service Broker returns a list of appropriate services.

3. The Service Requestor selects an appropriate service and binds to the appropriate Service Requestor to obtain the service.

The problem in this scenario is that matching is just based on the prescribed preferences of the Service Requestor and not on the actual behaviour of the service Requestor. In fact, all state-of-the-art approaches neglect the actual behaviour of the Service Requestor when ranking the found services. For example, such a state-of-the-art approach for ranking Service Offerings offered by a Service Broker to a Service Requestor, in which the Service is offered by a third party, that means a Service Provider, is disclosed in U.S. Pat. No. 6,029,195.

The patent proposes a method for classifying objects, called target objects, and matching those classified target objects against the requirements of a user and providing a ranked list of matching target objects; ranking being done by suspected significance to the user. It does this by creating an electronic identification, called target profile, for each of said target objects. The target profile of the target object is for example, constructed on the frequency with which each word appears in article relative to its overall frequency in all of the articles. In addition, the system maintains for each user a target profile interest summary, which describes the user's interest level in various types of target objects. The system then evaluates the target profiles against the user's target profile interest summaries to generate a user-customized rank ordered listing of target objects most likely to be of interest to each user so that the user can select from among the potentially large number of selected objects.

Some mathematical model is used to carry out said evaluation that means the comparison of the electronic identification of the target object and the user preference. The approach may be adapted to objects different in nature by using different respective algorithms.

There are several disadvantages using such a mathematical model:

It is extremely difficult to find the correct mathematical model that exactly reflects sophisticated and complex user preferences.

If a new property is added, the mathematical model needs to be modified accordingly, which in general is not a trivial task.

The user preferences have to be defined by the user himself, for example by filling out a respective form and transmitting it to the Service Broker. That means the quality of the ranking of the list depends on the precision with which the user could describe his or her preferences.

1.3 Objectives of the Invention

It is thus an objective of the present invention to provide a method and respective system for computerized ranking of Service Offerings which is more flexible and does not depend on an inflexible mathematical similarity definition.

### SUMMARY AND ADVANTAGES OF THE INVENTION

This objective of the invention is achieved by the features stated in enclosed independent claims. Further advantageous arrangements and embodiments of the invention are set forth in the respective subclaims.

According to the most basic aspect of the present invention a method and respective system is disclosed for ranking service offerings offered by a Service Broker to a Service Requestor, the method being characterized by running at least the result list of qualifying services generated as the result of a query of the Service Requestor through a (trained) data-mining model which generates a newly ranked result list that better meets the preferences of the Service Requestor. Note in data-mining terminology this type of processing is called application phase.

The trained data-mining model is trained by feeding an untrained data-mining model with some or all of the following information:

Properties of the offered service,

Queries that Service Requesters have submitted

The lists of services that have been derived from said queries,

Feedback information provided by the Service Requester about his/her preferences,

Properties of the Service Requester,

Properties of the Service Provider -see FIG. 2 description further below.

Note, that this task of training a data-mining model is also referred to a data-mining being in the training phase.

Feedback information may comprise all kinds of information provided by the Service Requestor, such as selection of a particular service from a list of requested services (for example not selecting the top-ranked service), or the quality of service rendered by the selected Service Provider. This information is not limited to textual information; it may well be audio information or images.

The feedback is advantageously collected without any assistance required from the Service Requester. This can be done through a set of different techniques, such as automatically recording the selection being made by the Service Requester, or even the history in which the Service Requester looked at the different services being part of the presented list. It should be noted however, that the method of collecting feedback information has no impact on the quality of the work that is being carried out by the data-mining module. That means, even an explicit feedback requested from the Service Requester could be used advantageously.

Thus, according to the invention, the prior art methodology of Data Mining is used advantageously by the Service Broker for predicting the user's preference when creating a Service Requestor specific ranked list of qualifying services as a result of a Service Requester's request to a Service Broker.

Thus, the ranking may advantageously benefit from existing technology dedicated to and specialized for detecting unknown new trends and correlation between the different but related pieces of information. Using this inventional approach complicated mathematical algorithms can be avoided the maintenance of which requires highly skilled and specialized programmer staff. Instead, the existing Know-How of Data Mining technology can be applied to ranking services.

Of course, the execution of the data-mining model and the management of the input data to the data-mining model can be carried out in various places: the Service Broker can carry it out; the Service Requester can carry out, or even a combination thereof.

Furthermore, the more information (more of the same type of information as well as more of different types of information) that is provided during the training phase as well as appropriate information when carrying out ranking of a list, the better the result of the ranking the list will be. The minimum that is required to make the proposed method work is the list of services and the appropriate feedback of the Service Requester when training the data-mining model and the list of services when carrying out the ranking.

### BRIEF DESCRIPTION OF THE DRAWINGS

The present invention is illustrated by way of example and is not limited by the shape of the figures of the drawings in which:

FIG. 1 illustrates the structure of a service-oriented architecture showing the interactions between Service Broker, Service Requestor, and Service Provider according to a preferred application of the present invention,

FIG. 2 illustrates which information potentially flows through the (trained) data-mining model when generating a ranked list of services,

FIG. 3 lists the basic steps involved in generating the ranked lists and generating the data for further or even initial training of the data-mining model, and

FIG. 4 illustrates the creation of the trained data-mining model from an untrained data-mining model by feeding the untrained data-mining model with appropriate information.

### DETAILED DESCRIPTION OF THE PREFERRED EMBODIMENT

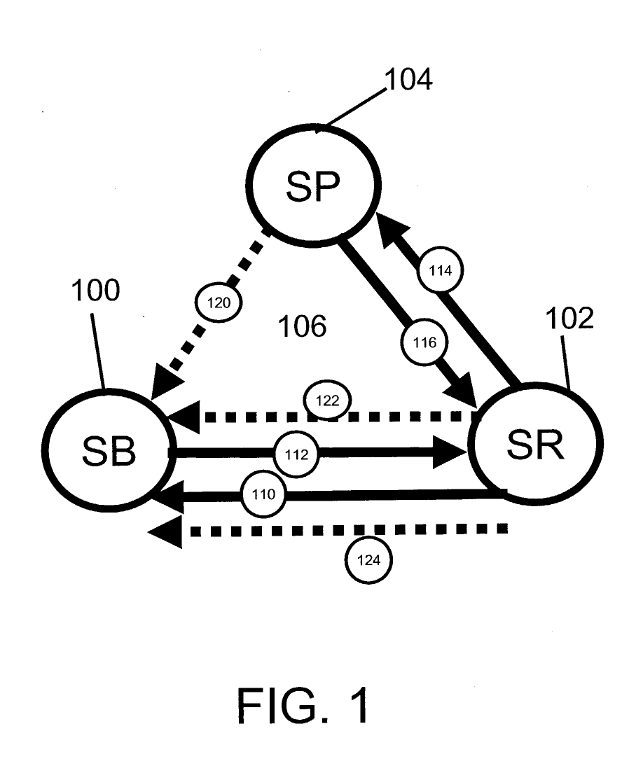

FIG. 1 shows the basic structure of a service-oriented architecture (SOA), comprising at least one Service Broker (SB) 100, at least one Service Requestor (SR) 102, and at least one Service Provider (SP) 104, connected via some communication mechanism, for example the Internet 106.

The Service Providers provide/offer services, Service Requesters need services, and Service Brokers maintain information about said services and Service Providers. Said Service Brokers assist said Service Requestors in finding, for a particular service, the best services from the best Service Providers ranked by the importance for said Service Requestor.

When a Service Requester needs some service, s/he submits a query to the Service Broker 110 (in SOA-terminology find), and the Service Broker returns a list of suitable services—step 112. The Service Requester then requests from a selected Service Provider the provision of the service (in SOA-terminology binds to a Service Provider)—step 114, which then provides the requested service—step 116. Service Providers typically provide their information (about the services and the Service Provider itself) to the Service Broker (in SOA-terminology publish)—step 120.

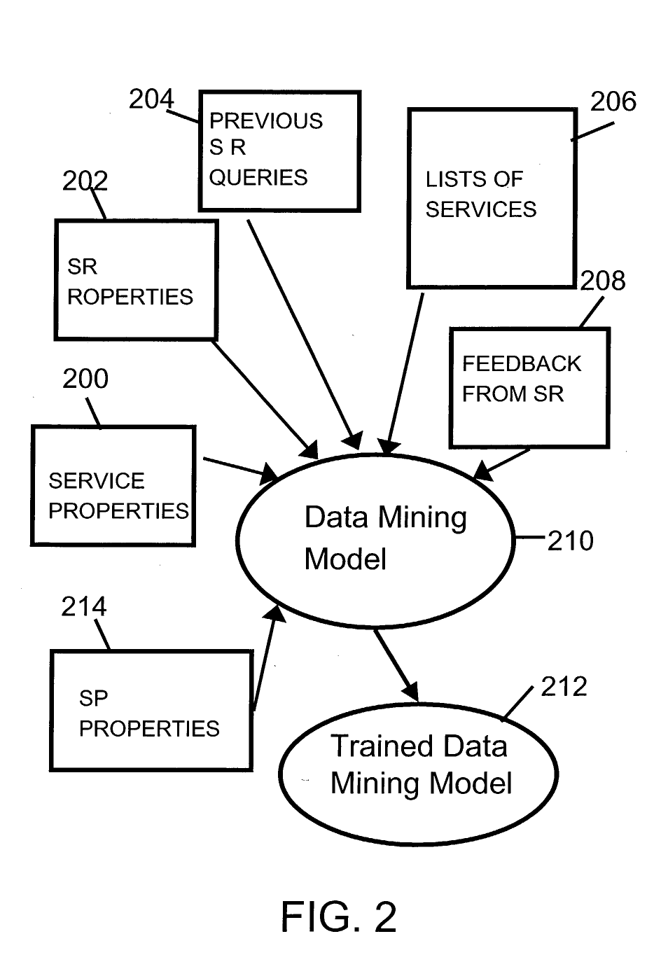

FIG. 2 illustrates the training of the data-mining model with some or all of the following information:

Properties 200 of the offered services,

Queries 204 that Service Requesters have submitted,

The lists 206 of services that have been derived from said queries 204,

Feedback information 208 provided by the Service Requester about his/her preferences,

Properties of the Service Requester 202,

Properties of the Service Provider 214.

The lists of services 206 contain for each query submitted by a Service Requester the list of services that have been returned as the result of the queries 204. The order of the services within the individual lists is immaterial (that means the actual algorithm that has been used for ranking the lists has no influence on the training results).

Properties of the Service Requesters 202 may be any information that is associated with Service Requesters. These properties could come in any form, such as textual descriptions or images. Typical examples of properties of Service Requesters are age, martial status, or income. The collection of the properties could have been done either explicitly, ie, with assistance of the Service Requester, or implicitly, ie, without assistance of the Service Requester.

Properties 214 of Service Providers may be any information that is associated with Service Providers. These properties could come in any form, such as textual descriptions or images. Typical examples of properties of Service Providers are address, size of company, or financial rating. The collection of the properties could have been done either explicitly (with assistance of the Service Provider) or implicitly (without assistance of the Service Provider).

Queries 214 of the Service Requestors are the queries that have been submitted by Service Requesters.

Feedback information 208 may comprise all kinds of information provided by Service Requestors (indicated by the arrow 122 in FIG. 1), such as selection of a particular service from a list of requested services—for example not selecting the top-ranked service, or information about the quality of service rendered by the selected Service Provider. This information is not limited to textual information; it may well be audio information or images. In fact, this feedback information provides one piece of the information about the preferences of the Service Requesters.

The minimum information that needs to be provided for training the data-mining model is the lists 206 of services and the feedback information 208 provided by the Service Requesters. In this case, only the list of qualified services must be made available to the data-mining model, when performing ranking. All other information made available to the trained data-mining model, such as the original query, will have no impact.

The quality of the ranked list can be improved by feeding the other pieces of information shown in FIG. 2 into the data-mining model during the training phase:

The properties 200 of the services. No additional information needs to be provided when creating the ranked list.

The properties 214 of the Service Providers associated with the services. In this case, one needs to supply the identification of the Service Provider for each of the services in the list when creating the ranked list.

The original ie, previous queries 204. In this case, one needs to supply the query when creating the ranked list.

The properties 202 of the Service Requesters. In this case, one needs to supply the identification of the Service Requester when creating the ranked list.

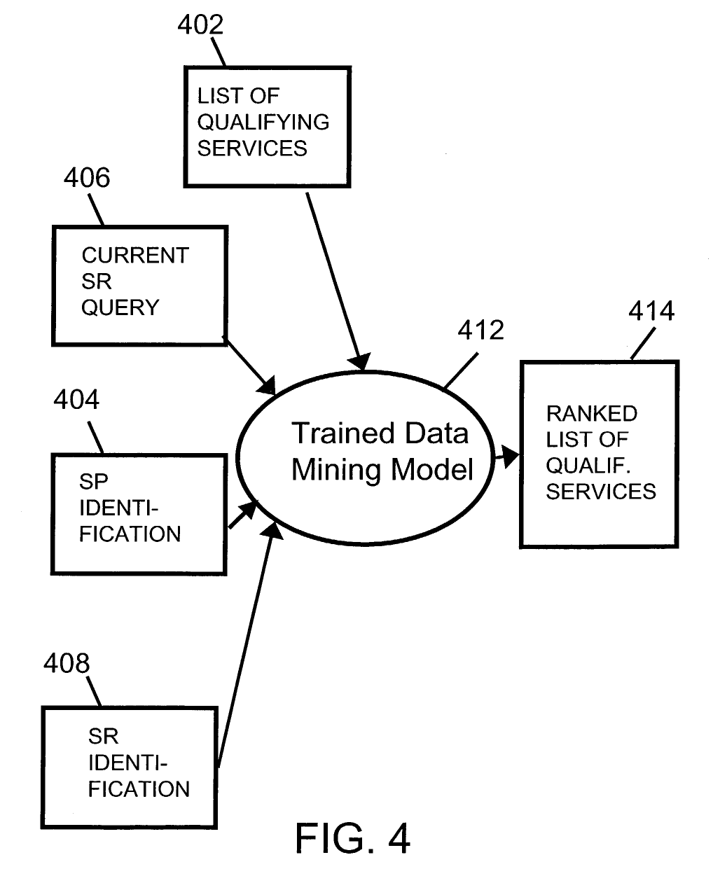

FIG. 4 illustrates the ranking of a list of services that has been created as the result of processing a query of a Service Requester. Input to the data-mining model is some or all of the following information:

The list of qualifying services 402 that have been derived from the current query of the Service Requester 406,

The query 406 that the Service Requester submitted,

The identification 408 of the Service Requester,

The identifications 404 of the Service Providers.

As a minimum the list of qualifying services 402 must be made available to the data-mining model when creating the ranked list.

The quality of the ranked list can be improved by feeding the data-mining model with other pieces of information shown in FIG. 4:

The original queries 406. In this case, one needs to train the data-mining model with the previous set of queries 204 of FIG. 2.

The identification of the Service Requester 408. In this case, one needs to train the data-mining model with the properties of the Service Requesters that had submitted the set of queries 202 of FIG. 2.

The identification of the Service Providers 404 that provide the services. In this case, one needs to train the data-mining model with the properties of the Service Providers 214 of FIG. 2.

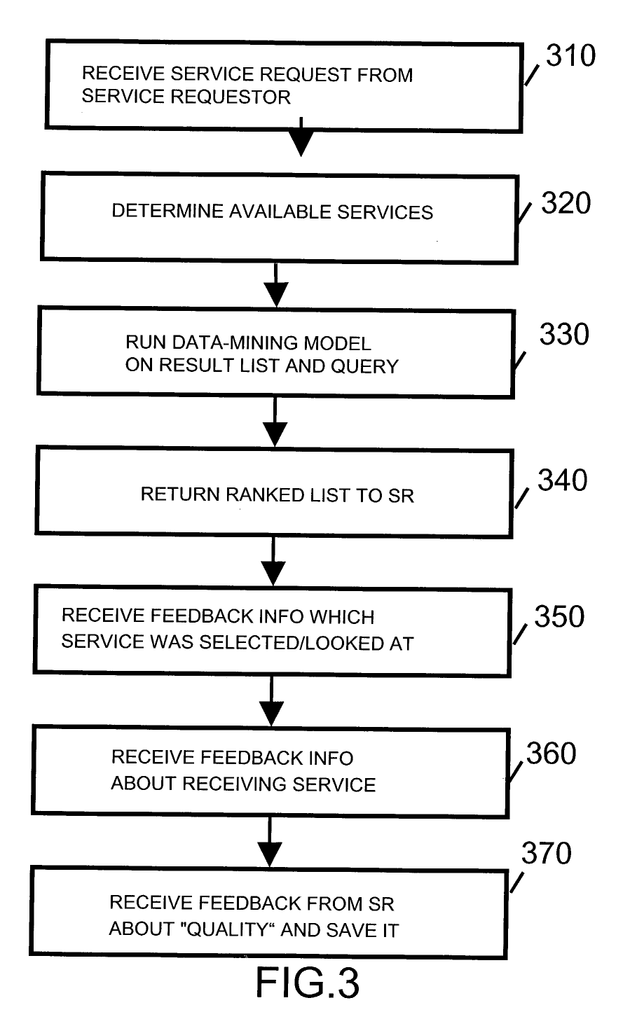

FIG. 3 illustrates schematically the steps that the Service Broker 100 carries out during the life cycle of a request from a Service Requester 102.

In the first step 310 the Service Broker receives the request from the Service Requester. It processes the request by determining available services by generating from the query a list of qualified services—step 320, runs the data-mining model on the result list, ie, passes the list of qualified services to the data-mining model for creation of the appropriately ranked list—step 330, and returns the ranked list to the Service Requester—step 340.

After the Service Requester has selected or even not selected a particular service, the appropriate information about the actions of the Service Requester (selecting a service, looking at a service) is sent back to the Service Broker and collected by the Service Broker—step 350. Additional feedback information about how the Service Provider reacted to a service request is provided in step 360. Finally, after the Service Requestor has used the service, information about the quality of service is sent back to the Service Requester 370. The information collected in steps 350 till 370 is the feedback information that can be used later for further training the data-mining model or that is used for initially training the data-mining model. It should be noted, that the three types of collected feedback information is for example only; many more types of feedback information can be collected.

It should be noted that the present invention could advantageously predict the preferences for Service Requesters even for services, which the Service Requester has not seen before.

The present invention can be realized in hardware, software, or a combination of hardware and software. A tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general-purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notification; b) reproduction in a different material form.

1. A computerized method for ranking service offerings in a service-oriented architecture, in which said service offerings are offered by a Service Broker (100) to a Service Requestor (102), characterized by the step of:
running (330) at least a result list (402) of qualifying services (404) generated as the result of a query of the Service Requestor (102) through a trained data-mining model (412) for generating a newly ranked, improved result list (410).

2. The method according to claim 1, in which a data-mining model is trained by at least one of:
a) Properties (200) of the offered service,
b) Queries (204), that Service Requesters have submitted,
c) Lists of services (206) that have been derived from said queries (204),
d) Feedback information (208) provided by the Service Requester about his/her preferences,
e) Properties (202), of the Service Requester,
f) Properties (214) of the Service Provider.

3. The method according to the preceding claim in which said Feedback Information (208) comprises at least one of:
a) a selection of a particular service from a list of services, or
b) information about the quality of service rendered by a selected Service Provider (104).

4. The method according to claim 2, in which said Feedback Information (208) is collected without requesting assistance from the Service Requester (102).

5. The method according to the preceding claim, in which said Feedback Information (208) is collected by either of or a combination of:
a) automatically recording the selection being made by the Service Requester,
b) automatically recording the history information, in which the Service Requester looked at different Service Offerings being part of a presented list thereof.

6. The method according to claim 1 or 2, in which in addition to said result list (402) one or more of the following information is fed to a respectively trained data-mining model (412), when running it for generating said improved result list (410):
a) said queries (204, 406), that Service Requesters have submitted in case the data-mining model was trained with them,
b) said properties (214, 404) of the Service Providers, which are associated with said services (206), in case the data-mining model was trained with them, and
c) said properties (202, 408) of the Service Requesters, which are associated with said services (206), in case the data-mining model was trained with them.

7. A computer system having means for performing the steps of a method according to one of the preceding claims 1 to 6.

8. A computer program for execution in a data processing system comprising computer program code portions for performing respective steps of the method according to anyone of the preceding claims 1 to 6,
when said computer program code portions are executed on a computer.

9. A computer program product stored on a computer usable medium comprising computer readable program means for causing a computer to perform the method of anyone of the claims 1 to 6, when said computer program product is executed on a computer.
